(19) United States
(12) Patent Application Publication
(10) Pub. No.: US 2017/0109803 A1
(43) Pub. Date: Apr. 20, 2017

(54) METHOD AND SYSTEM FOR VISUAL SEARCH BASED USER-SPECIFIC AND CUSTOMIZABLE INVENTORY MANAGEMENT SYSTEM

(71) Applicant: Adeptech Systems, Inc., McLean, VA (US)

(72) Inventors: Anoop Kumar Kalra, McLean, VA (US); Yashwanth Gazula, Fairfax, VA (US); Amoghavarsha Esturi Sampangiram, Fairfax, VA (US); Shanmukha Bharat Vakalapudi, Fairfax, VA (US)

(21) Appl. No.: 15/283,497

(22) Filed: Oct. 3, 2016

Related U.S. Application Data
(60) Provisional application No. 62/236,931, filed on Oct. 4, 2015.

(51) Int. Cl. G06Q 30/06; G06Q 50/00

(52) U.S. Cl. CPC G06Q 30/0623; G06Q 50/01; G06F 17/30259

(57) ABSTRACT

Items with physical and temporal attributes are chronicled and organized visually through their user-generated images. For each image, item metadata is specified for later retrieval using image-matching techniques. For one embodiment, items forming an assembly are identified through their visual representation and useful metadata retrieved. Another embodiment, would allow users keep track of their property items by associating metadata, e.g. physical and origin attributes, acquisition source, relevant reviews, color, when used last time, type etc. with items' visual representation, including photographs, for later retrieval of metadata containing useful information about the item, by simply submitting another, existing or new photograph of the same item into the system. Another embodiment, would allow face recognition for images stored or acquired on users' personal or organizational computing device. Another embodiment would allow medical researchers catalog medical images, such as pathology slides, X-rays, nuclear magnetic resonance imaging, ultrasound, tomography etc. for classification based on certain trends in diagnoses. Under this embodiment, search for a given diagnosis may be automated for initial assessment whereby a medical expert may only need to consider a subset of possibilities.

The word ‘image’ in this document means a digital colored photograph.

### CROSS REFERENCE TO RELATED APPLICATIONS

The present applications claims priority to earlier filed provisional application having U.S. Provisional App. Ser. No. 62/236,931 for “A METHOD AND SYSTEM FOR VISUAL SEARCH BASED USER-SPECIFIC AND CUSTOMIZABLE INVENTORY MANAGEMENT SYSTEM” filed on Oct. 4, 2015, the contents of which are incorporated herein by reference in their entirety.

### PATENT CITATIONS

Doc. #: US20140254934A1

Pub. Date: Sep. 11, 2014

Doc. #: US20090094289A1

Pub. Date: Apr. 9, 2009

Doc. #: US20040078299A1

Pub. Date: Apr. 22, 2004

Doc. #: US20040078299A1

Pub. Date: Apr. 22, 2004

Doc. #: U.S. Pat. No. 8,218,873 B2

Pub. Date: Jul. 10, 2012

### BACKGROUND OF THE INVENTION

The field of computer vision is highly researched. While the driving force for computer vision has been optical character recognition, robotics and driverless vehicles, the resultant technology has been applied to visually searching for patterns and features for identifying people through face, fingerprint and retina recognition.

Recently, visual search techniques have been applied to aid consumers search retailers' catalogs for purchasing items by specifying visual representation of items rather than the traditional method of specifying item features like, category, size, color, gender dependence, price range etc. A typical search begins by a user submitting to a supplier's online system, an image of an item the user is planning to purchase. The system returns back with a number of suggestions, similar to the image of the item user submitted, for purchase. In another offering a major on-line retailer provides information about movies and television shows, once a user submits an image of a given scene.

There are also software applications for mobile platforms, broadly referred to as ‘app’ or ‘apps’, which provide background information about an item of interest to the user, upon submission of the item's image to the system. One such app allows users to upload image of wine-bottle labels and returns information about wines e.g., tasting notes, ratings, food pairings, etc. Some online photo storage sites use visual search technology to help its users group their photos based on people pictured. Another online social site uses similar technology to identify associates or friends of their subscribers to increase the degree of social connections. Currently available systems do not allow users to add their own image and manage related information about items of their interest. Providing users the ability to manage information about their items, in a way that is customizable, will yield benefit by retrieving relevant information about the items. The beneficial information may include the history and pattern of uses and acquisition and how item relates to certain events or assemblies etc.

Available image matching solutions, hitherto, are general purpose, whereby offering image matching for items of providers' or retailers' interest, additionally these systems require connections to backend servers through the Internet. Accordingly, there exists a need for a method and a system with user customizable options to capture, store and recognize or match items of users' interest. This invention allows users the ability to chronicle and manage information about their personal items and search such information by submitting, an existing or new, image of the items into the system. Another embodiment of the method and system allows users to operate while temporarily disconnected from the Internet, or other communication means.

### SUMMARY OF THE INVENTION

A customizable system in various embodiments provides users the capability to keep track of their items through visual search.

Most visual search systems' architecture follows model-view-controller pattern. Wherein the view component of the system interacts with the user, the controller component contains business logic of the system and the model component stores data for retrieval, based on commands it receives from the controller. From the standpoint of visual search systems, algorithms for image processing, search and matching are implemented in the controller component. This component is commonly referred to as the image-matching/search engine. A number of business entities offer their image-matching/search services through application programming interfaces (APIs.)

System Overview: The system consists of the following components:

a. Graphical User Interface Application (elsewhere referred to as the ‘app’) running on a device (cell phones, desktop, laptop and tablets) allowing users to capture images of objects subject to inventory management of any set of items.
i. The application allows the user to use the device's camera or another attached camera to take pictures.
ii. The application preprocesses images prior to submitting them for matching against previously taken pictures.
iii. The stored images/pictures in the application are associated with metadata with a number of attributes, including but not limited to Date(s) and time(s) of capture, place(s) based on GPS data among others. If image match is confirmed, the system returns the meta-data attributes of the image to the user.
iv. If detection is not confirmed, the application prompts the user for populating image attributes. User fillable attributes are free form fillable or list driven whereby user chooses a value from a set of predefined possibilities.
v. The appearance of the application is fully utilized for most screen sizes or scalable as such as well as pleasing disposition.

b. Imaging Database Middleware Sub-System brokers user requests for image search and matching. This system maintains a database of users and their images along with the related meta-data. This system contacts the Image Matching Engine for image matching of user images and conveys results of such requests to users. This system contains a report generation and search module for creating attributes or user based reports.

c. Image Matching Engine, an external system is used through available APIs for searching through previously deposited user images. The engine returns top matches by their filenames if a match occurs. Otherwise, a negative acknowledgement is sent back. In case of negative match the image is added to the user specific set of images and an appropriate matching signatures of the image be generated for future matching process.

### OBJECTS OF THE EMBODIMEMNTS

The primary object of the embodiments herein is to provide a method and system for providing visual search based customizable inventory management system whereby a user initiates an information query by submitting, an existing or new, image of the item of interest, captured using a digital camera or scanner, into the system for a match. If a match occurs, system responds back with desired information about the item. If a match does not occur, system responds back with a set of user input screens for the user to enter pieces of information about the item and records the image and the related information about the item in its database for future data requests.

In one embodiment of the invention, a user can manage information regarding household items, e.g. china, curios, antique items, tools, furniture, apparel, shoes, jewelry etc.

Another embodiment of the present invention is to provide a method and system for managing medical images for classifying diagnoses and related epidemiological studies.

Another embodiment of the present invention is to provide a method and system to identify insignia and uniforms through visual search.

Another embodiment of the present invention is to provide a method and system to identify and manage information about manufactured parts and how they relate to form certain assemblies.

Another embodiment of the present invention is to provide a method and system to identify and manage information about warehouse and store items upon which a label cannot be affixed.

Another embodiment of the present invention is to provide a method and system to identify and manage information about landmarks of the world in a way the user would prefer.

Another embodiment of the present invention is to provide a method and system to identify and manage features of geological objects of user's interest.

In another embodiment of the present invention it to provide members of the law enforcement community, a method and system for identifying local subjects related to criminal activities, either through a photograph of their face or personal identification artifact, or both.

The advantages of these and other embodiments of the present invention will become readily apparent from the detailed description presented with accompanying drawings, in this document below.

### BRIEF DESCRIPTION OF THE DRAWINGS

Reference will now be made to the accompanying drawings, which are not necessarily drawn to scale and labels used in these drawings are for illustrative purpose to encompass invention's various embodiments; nature of these labels to be used of words of description rather than of limitation, and wherein:

FIG. 1 [Welcome Screen] is a visual presentation of a the first screen of the user interface through which a user will either log-on to the system or choose to register for the service;

FIG. 2 [Register Screen] is a visual presentation of the screen through which a user will first register for the service;

FIG. 3 [Camera View Screen] is a visual presentation of the screen a user is presented when logged-in or when the application is started;

FIG. 3a [Items Collection] is a visual presentation of the screen a user is presented when the Collection icon is chosen;

FIG. 3b [Pix Gallery] is a visual presentation of the gallery of existing images stored on a user's device;

FIG. 4 [Captured Image] is illustrates choices a user is presented after an image is captured;

FIG. 5 [Meta Data Entry] shows a visual presentation of the screen when a user decides to accept a captured image for entry into the system;

FIG. 6 [Events] is a visual presentation of the screen where a user enters information about the object to be associated with the captured image;

FIG. 6a [Assembly (Events)] is a visual presentation of the screen when a user completes entering information about the captured image, listing events or collections or assemblies the item is categorized into;

FIG. 7 [Info] illustrates a screen displaying available information about the item with matched image in the database of the present invention. This screen also presents user the ability to share the captured image with an entity from the device's contacts database for a possible coordination.

FIG. 8 [Search] is a visual representation of the screen when a user wishes to search through the metadata about an item or items of interest.

FIG. 9 [App Guide] illustrates guidance on how to use available app options through their icons.

FIG. 10 [System Architecture] illustrates an overall system architecture.

FIG. 11 [System Architecture—No Connectivity] illustrates an overall system architecture when the user's connectivity to the system is severed.

### DETAILED DESCRIPTION OF THE INVENTION

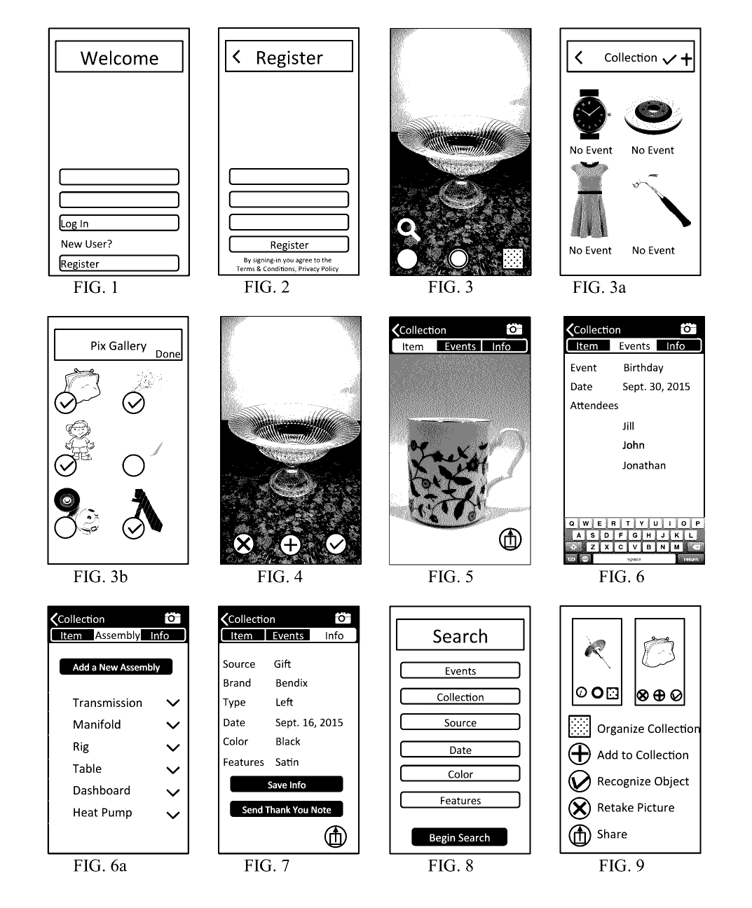

Referring now to the present invention in more detail, when user initiates the system a screen (FIG. 1) is presented. Through this screen the user either logins to the system, if previously registered, otherwise registers for the service offered by the system.

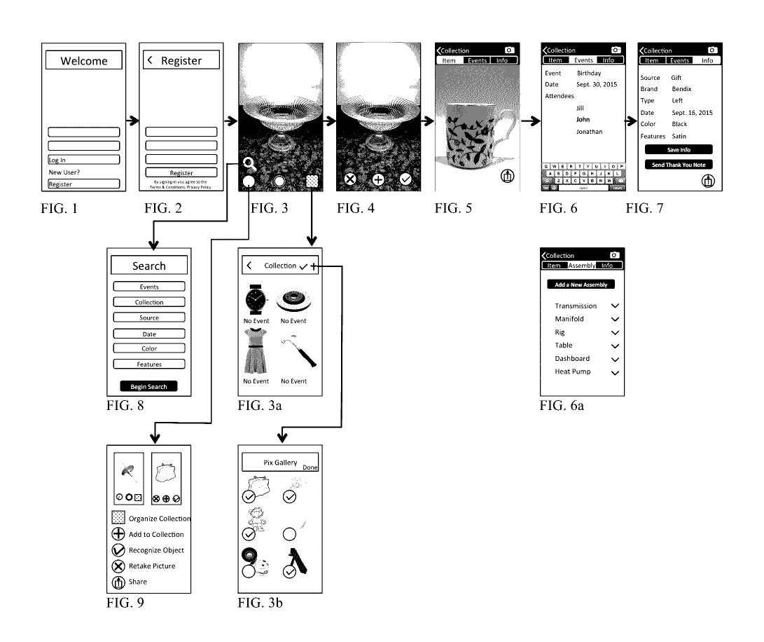

FIG. 2 shows the user registration screen, where a user provides an email address or a phone number along with a password with re-typed validation. Once user selects the Register button, an email, or a text message, is sent to the user with an activation link. This process confirms user's email or phone number. Once user clicks on the link, user's account is activated for use of the service.

Upon activation, user is presented with screen (FIG. 3) with a camera view. At the bottom center user is presented with a button to complete capturing the image of the item. On the right of the image capture button, an icon is presented which allows the user to select an image from the collection of previously taken images. FIG. 3a is an illustration of user's collection of previously taken images. User may select an image from this collection or add to this collection an image from user's gallery of previously taken picture of an item the user may want to include into the app's collection.

There are two other icons on the FIG. 3 screen, the icon with an ‘i’, when clicked will take the user to one or more screens which provide instructions on how to use the system.

The icon resembling a magnifying glass, when clicked presents user the options to search for items of interest based on previously recorded information.

Once the image capture button is selected in FIG. 3, the user is presented with three options, FIG. 4, a. an ‘X’ button, a ‘+’ button and a ‘✓’ button. The choice of ‘X’ indicates, the user retakes the picture, choice of ‘+’ allows the user to add the image to the user-specific collection for later handling. The choice of ‘✓’ button allows the user to submit the image for search.

The user submitted image is preprocessed and compressed, prior to transmission to the Imaging Middleware Database Subsystem. This sub-system proxies user's image for visual search. The subsystem adds user's image and its thumbnail into a user specific database along with the information about the image. This subsystem initiates a visual query against the image matching engine. The imaging engine responds with a ‘negative’ acknowledgement if the image was not previously recorded. If there is a match for the image, the image matching engine responds with top three (this number is configurable and not fixed) matches. The user selects one of the top three images. The user identified image is presented in a screen as depicted by FIG. 5. At this stage, the user may choose to share this image with other users or anyone else contained in their contacts database for further coordination.

FIG. 6 screen shows tabs that user chooses to enter pertinent information about the item. The system prepopulates date and location where the image was taken. User also associates the image with an event or an assembly or another grouping. In each of these cases user is allowed to choose predefined options or create new ones for each category of information. FIG. 6a illustrates user's ability to add the currently captured image to previously defined events, assembly or another grouping.

Once user provides information about the item of interest the next screen, FIG. 7 illustrates options the user is presented to save the entered information or communicate about the item with another user of the system or from user's contacts database.

In the event of a match, the user is presented with information about the item as shown in FIG. 7. All menu choices and their values are drawn from configuration files for localization of the app.

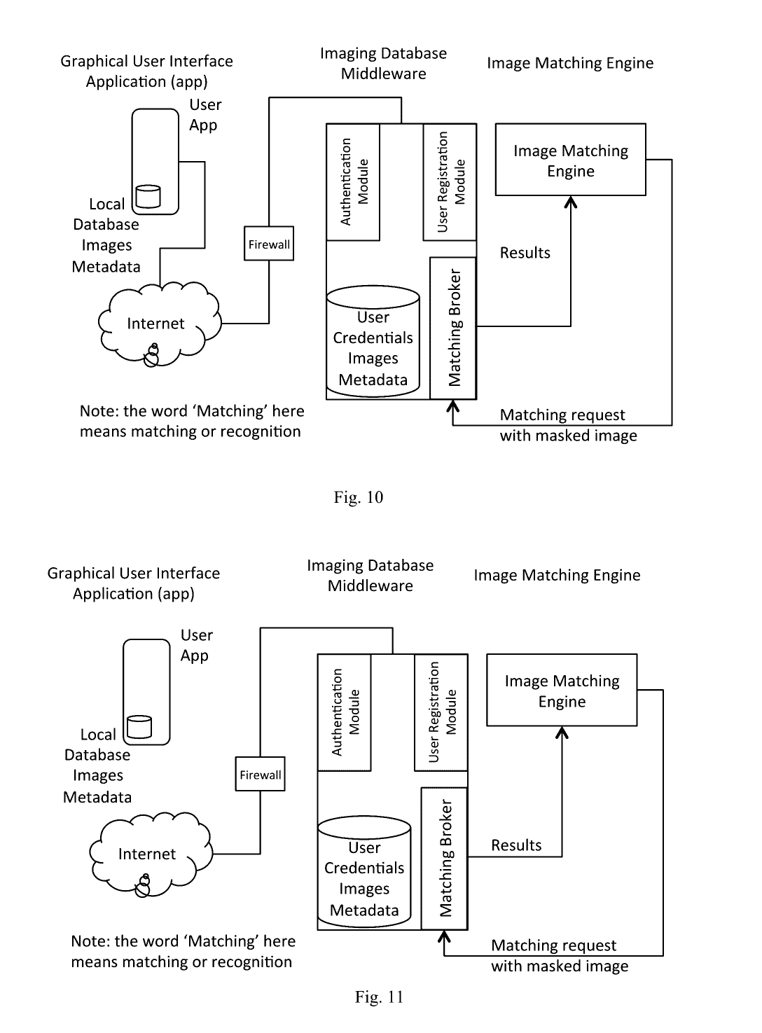

Overall System Architecture—(FIGS. 10 and 11) depicts the over all system architecture. The app connects to the infrastructure components of the system through either the Internet or another means of network connectivity. The user securely connects with the backend infrastructure through a security firewall for user authentication or registration. The registration process initiates an email or a message to be sent back to the user's provided email address or phone number with a link for validation of the originating users. Once the user clicks on the provided link, user's app is activated.

Activated users submit their image matching requests by communicating with the Middleware. Once user credentials are authenticated, a copy of their image is added to the database and an encrypted form of the user's identity is created for submitting request to the Image Matching Engine for matching or recognition. FIG. 11 illustrates system operation when a user looses network connectivity with the backend infrastructure. The app keeps a local copy of user's images and metadata on the remote device for local matching of user images.

The advantages of the present invention include, without limitation, a customizable and user extensible method and system for managing information, including history, of items of interest, without relying on user's memory. In most cases labels and other identifying marks are lost from items of interest, therefore submitting user queries through items' images rather than relying on subjective description about the item.

While the foregoing written description of the invention enables one of even ordinary skill to make and use what is considered presently to be the best mode thereof, those of even ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Although the embodiments herein are described with various specific embodiments, it will be obvious for a person skilled in the art to practice the invention with user-specified customizations. However, all such modifications are deemed to be within the scope of the claims.

It is also to be understood that the following claim is intended to cover all of the generic and specific features of the embodiments described herein and all the statements of the scope of the embodiments, which as a matter of language might be said to fall there between.

What is claimed is:

1. A customizable and user extensible method and system for managing information about items of interest through visual search.
